(19) United States
(12) Patent Application Publication
(10) Pub. No.: US 2014/0057503 A1
(43) Pub. Date: Feb. 27, 2014

(54) FLEXIBLE TERMINAL

(71) Applicant: ASKEY COMPUTER CORP., New Taipei City (TW)

(72) Inventor: Po-Sheng WANG, New Taipei City (TW)

(73) Assignee: ASKEY COMPUTER CORP., NEW TAIPEI CITY (TW)

(21) Appl. No.: 13/685,311

(22) Filed: Nov. 26, 2012

(30) Foreign Application Priority Data
Aug. 21, 2012 (TW) 101130317

(51) Int. Cl. H01R 13/02

(52) U.S. Cl. CPC H01R 13/02
USPC 439/884

(57) ABSTRACT

A flexible terminal includes two flexible parts and a connecting part. Each flexible part includes an outer segment having a first end and a second end, a first bent segment having one end coupled to the first end, and an inner segment coupled to the other end of the first bent segment. The connecting part is coupled to two second ends of the outer segments. Due to the flexible arrangement of the flexible parts, the flexible parts can be flexibly deformed to fit the dimension of a fastening element. In addition, the inner segments of the flexible terminal can clip the fastening element so as to avoid the relative displacement of the flexible terminal and the fastening element during the operation.

### CROSS REFERENCE TO RELATED APPLICATIONS

This Non-provisional application claims priority under 35 U.S.C. §119(a) on Patent Application No(s). 101130317 filed in Taiwan, Republic of China on Aug. 21, 2012, the entire contents of which are hereby incorporated by reference.

### BACKGROUND OF THE INVENTION

1. Field of Invention

The invention relates to flexible terminal and, in particular, to a terminal that can be flexibly deformed corresponding to the dimension (e.g. diameter) of a fixing part during the fixing procedure.

2. Related Art

Cable terminals are widely used in all kinds of electronic equipment. The conventional cable terminals can be divided into R-type terminals and Y-type terminals.

Referring to FIGS. 1A and 1B, a conventional R-type terminal includes a screw-coupling part 10 and a cable-fastening part 11, and the screw-coupling part 10 is coupled to the cable-fastening part 11. The screw-coupling part 10 has a through hole 100, which has a pre-determined hole diameter, and the dimension of the screw-coupling part 10 is pre-determined and cannot be modified.

The cable-fastening part 11 is used to connect to a cable. A screw passes through the through hole 100 of the screw-coupling part 10 and is then fastened at a pre-determined position of the electronic equipment, so that the cable and the electronic equipment are under an electrical connection state.

As shown in FIGS. 2A and 2B, a conventional Y-type terminal includes a screw-coupling part 20 and a cable-fastening part 21, and the screw-coupling part 20 is coupled to the cable-fastening part 21. The screw-coupling part 20 has an opening 200, which has a pre-determined dimension, and the dimension of the screw-coupling part 20 is pre-determined and cannot be modified.

The cable-fastening part 21 is used to connect to a cable. A screw passes through the opening 200 of the screw-coupling part 20 and is then fastened at a pre-determined position of the electronic equipment, so that the cable and the electronic equipment are under an electrical connection state.

The above describes the circumstance that an R-type terminal or a Y-type terminal is connected with a screw. However, the through hole 100 has a fixed hole diameter (see FIG. 1A), and the opening 200 also has a fixed dimension (see FIG. 2A). If the dimension of the screw is smaller than the hole diameter of the through hole 100 or the dimension of the opening 200, the R-type terminal or the Y-type terminal may be relatively moved easily during operation. This movement may further cause the short-circuit issue of the electronic equipment. Furthermore, it is also possible that the screw cannot fasten the R-type terminal or the Y-type terminal.

If the dimension of the screw is larger than the hole diameter of the through hole 100 or the dimension of the opening 200, the screw will not be able to fasten the R-type terminal or the Y-type terminal.

Therefore, it is an important subject of the invention to provide a terminal which can be flexibly deformed corresponding to the dimension of the fastening element during the fastening procedure.

### SUMMARY OF THE INVENTION

In view of the foregoing subject, an objective of the invention is to provide a terminal which can be flexibly deformed corresponding to the dimension (e.g. diameter) of the fastening element during the fastening procedure.

To achieve the above objective, the present invention discloses a flexible terminal comprising two flexible parts and a connecting part. Each flexible part includes an outer segment, a first bent segment and an inner segment. The outer segment has a first end and a second end. One end of the first bent segment is coupled to the first end, and the inner segment is coupled to the other end of the first bent segment. The connecting part is coupled to the two second ends.

In one embodiment, a first opening is formed between the two first bent segments, a fastening hole is formed between the two inner segments, and the first opening communicates with the fastening hole.

In one embodiment, each of the flexible parts further comprises a second bent segment and a buffer segment, and two ends of the second bent segment are coupled to the buffer segment and the inner segment respectively.

In one embodiment, the dimensions and/or shapes of the outer segments, the first bent segments and the inner segments of the flexible parts are the same or different. In addition, the outer segment, the first bent segment and the inner segment are separated elements and can be assembled together; otherwise, the outer segment, the first bent segment and the inner segment can be integrally formed as one piece.

In one embodiment, the dimensions and/or shapes of the outer segments, the first bent segments, the inner segments, the second bent segments and the buffer segments of the flexible parts are the same or different. In addition, the outer segment, the first bent segment, the inner segment, the second bent segment and the buffer segment are separated elements and can be assembled together; otherwise, the outer segment, the first bent segment, the inner segment, the second bent segment and the buffer segment can be integrally formed as one piece.

As mentioned above, the flexible terminal of the invention includes a flexible part, which has certain flexibility. When being fixed with the fastening element (e.g. a screw or a pin), the flexible part can be flexibly deformed corresponding to the dimension of the fastening element. Therefore, the flexible terminal is suitable for fastening elements of different dimensions. Furthermore, the fastening elements can be clipped by the inner segments of the flexible terminal, thereby preventing the relative displacement of the flexible terminal during operation.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a conventional R-type terminal;

FIG. 1B is a cross-sectional diagram of the conventional R-type terminal shown in FIG. 1A;

FIG. 2A is a schematic diagram of a conventional Y-type terminal;

FIG. 2B is a cross-sectional diagram of the conventional Y-type terminal shown in FIG. 2A; and

FIG. 3 is a schematic diagram of a flexible terminal according to a preferred embodiment of the invention.

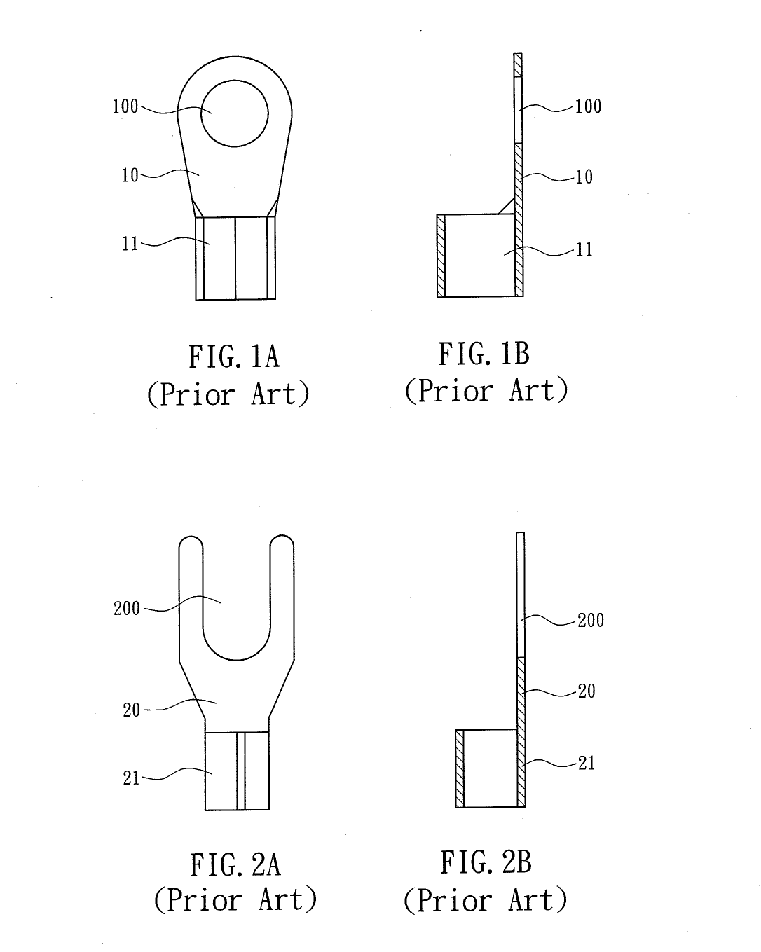

### DETAILED DESCRIPTION OF THE INVENTION

The present invention will be apparent from the following detailed description, which proceeds with reference to the accompanying drawings, wherein the same references relate to the same elements.

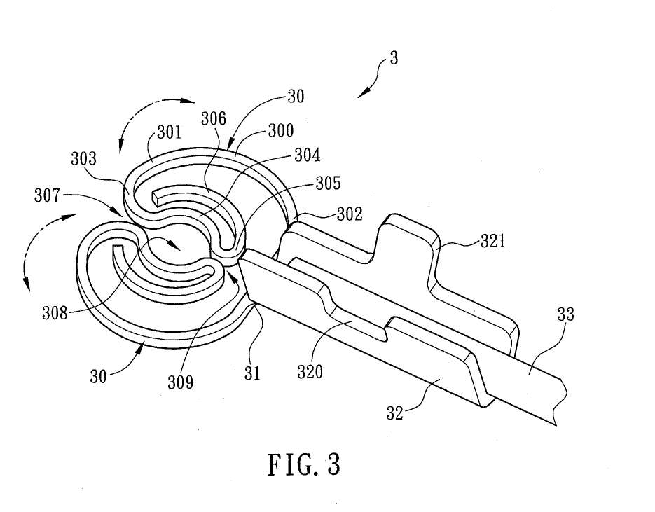

With reference to FIG. 3, a flexible terminal 3 includes two flexible parts 30 and a connecting part 31. Moreover, the flexible terminal 3 may further include a cable-fastening part 32 to connect to a cable 33.

Each of the flexible parts 30 includes an outer segment 300, a first bent segment 303 and an inner segment 304.

The outer segment 300 has a first end 301 and a second end 302, which are disposed opposite to each other and are the two tails of the outer segment 300. The connecting part 31 is coupled to the two second ends 302 so that the two flexible parts 30 are configured opposite to each other. Preferably, the two flexible parts 30 may be configured symmetrically.

One end of the first bent segment 303 is coupled to the first end 301, and a first opening 307 is formed between two first bent segments 303. The first opening 307 is designed to be smaller than the dimension of the fastening element (not shown), such as smaller than the diameter of a screw, to prevent the separation of the flexible terminal 3 and the fastening element when the flexible terminal 3 is fastened via the fastening element.

The inner segment 304 is coupled to the other end of the first bent segment 303, and a fastening hole 308 is formed between two inner segments 304. The fastening hole 308 communicates with the first opening 307. When the fastening element is a screw, the fastening element can be firmly fixed in the first opening 307, so that it is not easy to separate the fastening element from the flexible terminal 3.

The dimensions and/or shapes of the outer segments 300, the first bent segments 303 and the inner segments 304 of the flexible part 30 may be the same or different. In this case, the dimensions of the outer segments 300, the first bent segments 303 and the inner segments 304 of the flexible part 30 are, for example but not limited to, 1-5 mm. Furthermore, the outer segments 300, the first bent segments 303 and the inner segments 304 may be distinct segments connected together, or may be a one-piece part formed integrally.

The flexible part 30 may further include a second bent segment 305 and a buffer segment 306. The two ends of the second bent segment 305 are coupled to the inner segment 304 and the buffer segment 306 respectively. A second opening 309 is formed between the two second bent segments 305, and the second opening 309 communicates with the fastening hole 308. The second bent segments 305 are flexible.

In addition, the dimensions and/or the shapes of the outer segments 300, the first bent segments 303, the inner segments 304, the second bent segments 305 and the buffer segments 306 of the flexible part 30 may be the same or different. The dimensions of the outer segments 300, the first bent segments 303, the inner segments 304, the second bent segments 305 and the buffer segments 306 of the flexible part 30 are, for example but not limited to, 1˜5 mm. Furthermore, the outer segments 300, the first bent segments 303, the inner segments 304, the second bent segments 305 and the buffer segments 306 may be distinct segments connected together, or may be a one-piece part formed integrally.

The cable-fastening part 32 is coupled with the connecting part 31. The cable-fastening part 32 may be a plate body with a cross section substantially in a U shape. In practice, one side of the cable-fastening part 32 may further have a recess 320, and the other side of the cable-fastening part 32 may have a protrusion 321, which can be wedged in the recess 320 to clip the cable 33 tightly.

As mentioned above, the flexible terminal 3 of the invention is made of a conductive material, such as metal or alloy. The metal is, for example but not limited to, copper. Any conductive and flexible material may be used to manufacture the flexible terminal 3 of the invention.

Referring to FIG. 3 again, the cable-fastening part 32 tightly clips the cable 33. The cable-fastening part 32 is flexible so that the cable-fastening part 32 can be deformed to clip the cable 33. The protrusion 321 can be wedged into the recess 320 to make the connection between the cable-fastening part 32 and the cable 33 more firmly.

When the fastening element (e.g. a screw) enters into the fastening hole 308 via the first opening 307, or passes through the fastening hole 308 directly, to couple to a predetermined position of the electronic equipment, if the dimension of the fastening element is larger than that of the first opening 307, the flexible part 30 stretches outwardly so that the fastening element can enter into the fastening hole 308.

If the dimension of the fastening element is larger than that of the fastening hole 308, the flexible part 30 also stretches outwardly to enlarge the hole diameter of the fastening hole 308. The inner segments 304 of the flexible terminal 3 clip the fastening element to prevent the relative displacement of the flexible terminal during operation.

If the dimension of the fastening element is smaller than the fastening hole 308 as well as the first opening 307, the fastening element will not be separated from the flexible terminal 3.

When the flexible part 30 stretches out excessively, the buffer segments 306 provide a proper buffer to prevent the flexible part 30 from excessive deformation.

To sum up, the flexible terminal of the invention includes a flexible part, which has certain flexibility. When being fixed with the fastening element (e.g. a screw or a pin), the flexible part can be flexibly deformed corresponding to the dimension of the fastening element. Therefore, the flexible terminal is suitable for fastening elements of different dimensions. Furthermore, the fastening elements can be clipped by the inner segments of the flexible terminal, thereby preventing the relative displacement of the flexible terminal during operation.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A flexible terminal, comprising:
two flexible parts, each of the flexible parts comprising:
an outer segment having a first end and a second end,
a first bent segment, one end of which being coupled to the first end, and
an inner segment coupled to the other end of the first bent segment; and
a connecting part coupled to the two second ends.

2. The flexible terminal according to claim 1, wherein a first opening is formed between the two first bent segments, a fastening hole is formed between the two inner segments, and the first opening communicates with the fastening hole.

3. The flexible terminal according to claim 2, wherein each of the flexible parts further comprises a second bent segment and a buffer segment, and two ends of the second bent segment are coupled to the buffer segment and the inner segment respectively.

4. The flexible terminal according to claim 3, wherein a second opening is formed between the two second bent segments and communicates with the fastening hole.

5. The flexible terminal according to claim 3, wherein the dimensions and/or shapes of the outer segments, the first bent segments, the inner segments, the second bent segments and the buffer segments of the flexible parts are the same or different.

6. The flexible terminal according to claim 1, wherein the two flexible parts are configured opposite to each other.

7. The flexible terminal according to claim 1, further comprising:
a cable-fastening part coupled to the connecting part.

8. The flexible terminal according to claim 7, wherein one side of the cable-fastening part has a recess, another side of the cable-fastening part has a protrusion, and the protrusion wedges into the recess.

9. The flexible terminal according to claim 7, wherein the cable-fastening part is a plate body substantially in a U shape.

10. The flexible terminal according to claim 7, wherein the cable-fastening part is made of a flexible material.
